(19) United States
(12) Patent Application Publication
(10) Pub. No.: US 2009/0084271 A1
(43) Pub. Date: Apr. 2, 2009

(54) Boiler assembly for hot beverage dispenser

(75) Inventors: David K. Njaastad, Palatine, IL (US); Steve A. Lucier, Bolingbrook, IL (US)

Correspondence Address: PYLE & PIONTEK LLC, 221 N. LASALLE STREET, SUITE 1207, CHICAGO, IL, 60601, US

(73) Assignee: ImI Cornelius Inc

(21) Appl. No.: 12/283,669

(22) Filed: Sep. 15, 2008

Related U.S. Application Data
(60) Provisional application No. 60/995,797, filed on Sep. 28, 2007.

(51) Int. Cl. A47J 31/54

(52) U.S. Cl. 99/323.3; 222/146.5

(57) ABSTRACT

A boiler assembly for a hot beverage dispensing machine is characterized by a baffle that separates a cold water refill chamber of the boiler from a water heating and dispensing chamber of the boiler in a manner that provides for non-turbulent flow of cold water from the water refill chamber into the water heating chamber without substantial mixing of the cold refill water with the already heated water and, thereby, without lowering the overall temperature of the already existing heated water.

This application claims benefit of provisional application Ser. No. 60/995,797, filed Sep. 28, 2007.

### FIELD OF THE INVENTION

The present invention relates generally to boiler assemblies, and in particular to a boiler assembly for hot beverage dispensers.

### BACKGROUND OF THE INVENTION

Hot beverage dispensers, such as coffee dispensers, utilize a boiler for containing and heating water that may then be either mixed with or flowed through coffee to prepare a hot coffee beverage, or simply dispensed as plain hot water. In the case of a coffee machine adapted for commercial use, the boiler is usually coupled with a cold water supply for delivering, preferably in an automatic manner, cold water into the boiler to replace hot water drawn from the boiler. A valve in the cold water supply line may be controlled by a suitable system that monitors the level of water in the boiler and opens and closes the valve in accordance with sensed minimum and maximum levels of water in the boiler, such that when a minimum level of water in the boiler is sensed the valve is opened to deliver cold water into the boiler until a desired maximum level of water is sensed, whereupon the valve is closed.

In maintaining water in hot beverage dispenser boilers at appropriate levels, standard practice contemplates delivery of cold water into the boiler through an inlet tube that introduces replacement or refill water into a bottom area of the boiler. As is understood, in the absence of turbulence in the hot water in the boiler, heating of the water results in a generally uniform temperature stratification or gradient of the water in the boiler, such that the water is coldest at the bottom of the boiler and gradually increases in temperature in the upward direction toward the top of the boiler where it is the hottest A problem encountered in refilling a boiler with relatively cool replacement water is that the water is flowed in a relatively unrestricted jet stream into the bottom area of the boiler, which results in turbulence of the hot water already in the boiler, mixture of the relatively cool replacement water with the hot water, and a resultant decrease in the overall temperature of the hot water in the boiler as the water is brought by the turbulence to a generally uniform temperature throughout. This lowers the temperature of the water at one or more hot water outlets from the boiler to below a minimum desired temperature, which decreases boiler performance and requires additional time to reheat the water before properly heated water is available to be delivered from the boiler.

### OBJECTS OF THE INVENTION

An object of the present invention is to provide a boiler for a hot beverage dispenser, in which the occurrence of turbulence in hot water already in the boiler is decreased upon introduction of replacement water into the boiler.

Another object is to provide such a boiler in which a baffle plate extending vertically within the boiler separates incoming cold replacement water from hot water already in the boiler.

A further object is to provide such a boiler in which the baffle plate directs cold incoming replacement water to a bottom area of the boiler without causing substantial turbulence in overlying hot water.

### SUMMARY OF THE INVENTION

The present invention provides a boiler assembly for a hot liquid dispenser. The boiler assembly comprises a boiler tank for containing liquid; means separating the tank into a liquid receiving chamber and a liquid heating chamber; means establishing communication between the chambers through an elongate opening extending along and adjacent to a bottom wall of the tank; means for heating liquid in the liquid heating chamber; means for dispensing heated liquid from the liquid heating chamber; and means for delivering relatively cool liquid into the liquid receiving chamber for flow through the opening from the liquid receiving chamber into the liquid heating chamber to replace dispensed heated liquid without causing significant turbulence in the heated liquid.

In the disclosed embodiment of boiler assembly the separating means comprises a baffle plate extending from side to side and vertically within the tank. The baffle plate has one side spaced from a side wall of the tank to define the liquid receiving chamber between the one side and the tank side wall, and the liquid heating chamber is defined in the tank on an opposite side of the baffle plate. A bottom of the baffle plate extends toward but spaced from the tank bottom wall to define the elongate opening between the liquid receiving and liquid heating chambers. The liquid delivering means comprises a liquid supply line having an inlet coupled to a source of relatively cool liquid and an outlet located in tank liquid receiving chamber at a height generally medially of the height of the tank, and a valve in the supply line is operable to control a flow of liquid through the supply line. Also included is a liquid level sensing means for controlling operation of the valve to open the valve to flow liquid through the supply line and into the liquid receiving chamber upon sensing a minimum level of liquid in the liquid heating chamber and to dose the valve upon sensing a maximum level of liquid in the liquid heating chamber.

The invention also contemplates a method of heating liquid in and dispensing liquid from a boiler tank of a hot liquid dispenser, which method comprises the steps of defining a relatively small liquid refill chamber and a relatively large liquid heating chamber in the boiler tank; heating liquid in the liquid heating chamber; dispensing heated liquid from the liquid heating chamber; in response performance of the dispensing step, delivering relatively cool liquid into the liquid refill chamber; and in response to performance of the delivering step, flowing liquid from the liquid refill chamber into a bottom of the liquid heating chamber in a smooth non-turbulent flow of liquid with no substantial mixing of liquid from the liquid refill chamber with heated liquid in the liquid heating chamber.

In a disclosed practice of the method, the defining step is performed by placing a baffle in the boiler tank to define the relatively small liquid refill chamber in the tank on one side of the baffle and the relatively large liquid heating chamber in the tank on the other side of the baffle, and the flowing step is performed by placing the baffle in the boiler tank, such that a bottom of the baffle is spaced from the bottom of the tank to define an opening at the bottom of the tank between the liquid refill and liquid heating chambers. Advantageously, the liquid refill and liquid heating chambers extend generally vertically in the boiler tank, and the delivering step is performed by introducing relatively cool liquid into the liquid refill chamber at a location generally medially of the height of the tank. Also included is the step of sensing the level of liquid in the liquid heating chamber, and the delivering step is responsive to the sensing step to deliver relatively cool liquid into the liquid refill chamber when a minimum level of liquid is sensed in the heating chamber and to terminate delivery of relatively cool liquid into the liquid refill chamber when a maximum level of liquid is sensed in the heating chamber.

### BRIEF DESCRIPTION OF THE DRAWINGS

FIG. 1 is an exploded assembly view of a boiler for a hot beverage dispenser boiler, which boiler embodies the teachings of the present invention; and

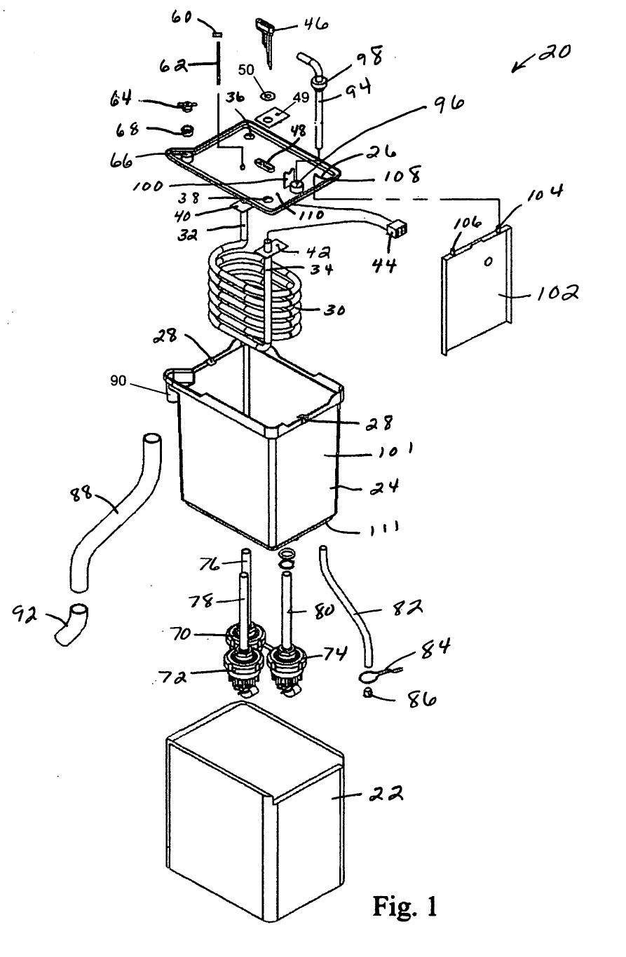

FIG. 2 is a cross-sectional side elevation view of the boiler as assembled.

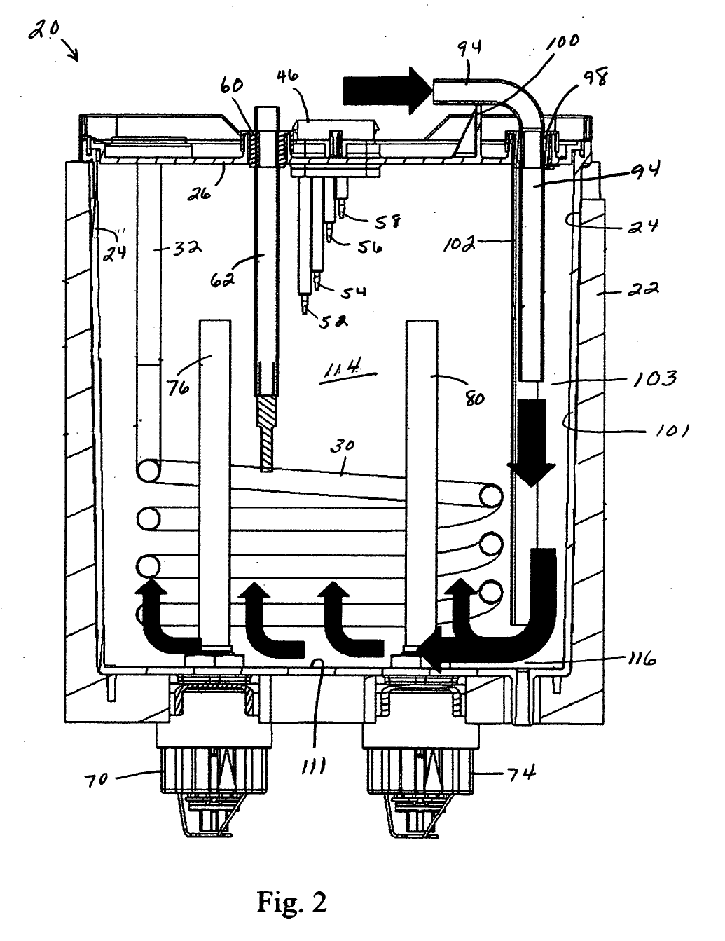

### DETAILED DESCRIPTION

The invention provides an improved boiler for heating water for hot beverage dispensing machines, such for example as coffee dispensing machines. For convenience, the boiler of the invention it will be described in the environment of coffee dispensing machines, although it is to be understood that the boiler finds application in other types of hot beverage dispensers.

Coffee making machines often utilize a boiler for heating and storing a volume of hot water so that, upon demand, hot water will be immediately available for use in preparing a hot coffee beverage for service to a customer. To avoid the need for and inconvenience of having to manually refill the boiler with water following withdrawal of hot water, the boiler may have a valve controlled cold water refill inlet coupled to a cold water supply for delivering, usually automatically, cold water into the boiler. The valve may be controlled by any suitable system that monitors the level of water in the boiler and actuates the valve in correspondence with sensed minimum and desired maximum levels of water, such that when a minimum level of water is sensed, cold water is flowed into the boiler until the desired level of water is sensed, whereupon the flow of cold refill water is terminated.

The boiler cold water refill usually comprises a tube, an inlet to which is connected to a cold water supply and an outlet from which is positioned to deliver cold water into the bottom of the boiler. The cold water normally is delivered into the bottom of the boiler in an relatively narrow unrestricted stream that creates substantial turbulence in the hot water already in the boiler, as a result of which the cold water mixes into the already heated water and decreases the temperature of all of the water at all of the levels in the boiler, thereby reducing the temperature of the water at one or more outlets from the boiler to below a desired dispensing temperature. This decreases boiler performance and requires additional time to reheat the water to a proper temperature for dispensing.

The invention overcomes the disadvantages of the prior art by providing a boiler for hot beverage dispensers that is automatically refilled with cold water in such manner that the incoming cold water does not create substantial turbulence in, and does not substantially mix with, the heated water already in the boiler. The result is retention of a generally uniform temperature gradient of the water in the boiler, improved boiler performance and the ability to immediately dispense a hot beverage without a need to first reheat the water.

The drawings show an improved boiler, indicated generally at 20, for a hot beverage dispensing machine. The boiler includes an outer insulating jacket 22 and a boiler tank 24 disposed within the outer jacket A top cover 26 closes the upper end of the boiler tank and is provided with apertures for mounting various boiler components such that, when the cover is on the tank, the components are generally situated within the tank. The cover 26 is releasably held on the tank 24 by a plurality of retaining clips 28 and carries a helically shaped electric water heating element or coil 30 that is situated within the tank and has at its opposite ends vertical extensions 32 and 34 that pass through associated apertures 36 and 38 in the cover and that are attached to the cover by plates 40 and 42. The heating element receives power via a connector 44 that couples voltage to the ends of the heating element extensions 32 and 34. Water is in the tank for being heated by the heating element 30 and also attached to the top cover 26 and extending into the interior of the tank 24 is a water level sensor assembly 46. The water level sensor assembly extends through an opening 48 in the cover 26 and is mounted on and sealed to the cover by a retaining plate 49 and seal 50. At its lower extension within the tank, the water level sensor has four downwardly extending water level sensing elements 52, 54, 56 and 58, the lower ends of which are electrically conductive and are located at selected and different vertical heights within the tank in accordance with selected and different levels of water in the tank. The lower electrically conductive end of the element 52 is the lowest in the tank and is a common electrical connection, and is intended to always be in electrical contact with water in the tank. The lower electrically conductive end of the element 54 is located vertically above the lower end of the element 52 and defines a low level of water in the tank, as indicated by water reaching the lower end of the element 54 and establishing an electrical connection between the elements 52 and 54. The lower electrically conductive end of the element 56 is located vertically above the lower end of the element 54 and defines a filled or upper level of water in the boiler tank, as indicated by water reaching the lower end of the element 56 and establishing an electrical connection between the elements 52 and 56. The lower electrically conductive end of the element 58 is located vertically above the lower end of the element 56 and defines an overfilled level or condition of water in the boiler tank, as indicated by water reaching the lower end of the element 58 and establishing an electrical connection between the elements 52 and 58. As is understood by those of skill in the art, the specific electrical connections established between the lower conductive end of the common element 52 and the lower conductive ends of the elements 54, 56 and 58 are used to control delivery of water into the boiler tank in a manner to maintain a level of water in the tank between a selected lower level as defined by the bottom of the element 54 and a selected upper level as defined by the bottom of the element 56. Should the level of water fall below the lower end of the element 52 or rise to the lower end of the element 58, that is considered to be indicative of a water fill system failure and the boiler is automatically turned off. Also mounted on the top cover by a grommet 60 and extending downward into the boiler tank interior is a water temperature sensor 62 for sensing the temperature of heated water in the boiler tank 24 and for controlling application of electrical power to the heating element 30 to maintain the temperature of the water within a selected temperature range. In addition, a temperature clixon overboil 64, attached to the cover about a cover aperture 66 by a grommet 68, senses the presence of steam and accommodates the passage of steam to atmosphere.

To withdraw hot water from the boiler tank 24 for delivery to dispensing stations, for example to two coffee dispensing and one hot water dispensing stations (none shown), three coil controlled water valves 70, 72 and 74 are attached to a bottom wall 111 of the tank and include respective hot water outlet tubes 76, 78 and 80 that extend through the tank bottom wall to hot water inlet ends to the tubes at selected locations within the tank. So that the tank 24 might be drained of water, such as for service or repair, a drain tube 82 is coupled at its upper inlet end to a drain outlet from the tank and is dosed toward its lower outlet end by a removable pinch clamp 84, with a plug 86 being inserted into the outlet from the hose as backup against accidental drainage. In addition, to direct any overflow water to a drain should the boiler tank be overfilled, a drain tube 88 connects to an overflow outlet 90 at an upper end of the tank and carries a fitting assembly 92 at its lower end for attachment to a drain.

To the extent described, the boiler assembly 20 is generally conventional and, if fully conventional, would include a water refill inlet that directs a flow of cold water into the bottom of the boiler tank 24 in a manner that creates substantial turbulence in the heated water already in the tank and mixes incoming cold refill water with the hot water already in the tank, thereby disrupting the generally uniform temperature stratification or gradient of the hot water in the tank and lowering the temperature of the water at all levels in the tank, including at the levels of the inlets to the hot water outlet tubes 76, 78 and 80. The undesirable result would be a generally uniform reduction in the temperature of the hot water in the tank and at the inlets to the hot water outlet tubes, which would require reheating of water in the tank before water at a desired hot temperature could again be dispensed from the tank. Performance of the hot water boiler would therefore be reduced and delays would be encountered in dispensing hot water from the boiler. Therefore, to overcome these disadvantages of the prior art, the invention contemplates a novel structure for and manner of introducing relatively cold refill water into the boiler tank 24 in such manner as to refill the tank without creating substantial turbulence in the hot water already in the tank and without substantial mixing of the relatively cool refill water with the hot water. The invention thereby avoids a reduction in the overall temperature of the hot water in the tank upon introduction of cold refill water into the tank, and avoids the need to delay further dispensing of hot water while water in the tank is reheated.

To this end, the invention contemplates that the boiler assembly 20 be provided with a cold water refill tube 94 that extends through an opening 96 in the top cover 26 within a sealing ring 98. An upper horizontally extending portion of the cold water inlet tube 94 is supported on a cradle 100 extending upward from a top surface of the cover and a lower end of the tube extends vertically downward through the tank 24 generally adjacent to a tank side wall 101, to a lower cold water outlet end of the tube located about medially of the vertical height of the tank. Absent more, relatively cold refill water exiting the outlet from the tube 94 would create substantial turbulence in the hot water already in the boiler tank 24 and mixing of the cold refill and hot water would occur. To prevent his from happening, the invention contemplates that a baffle plate 102 be provided generally adjacent to and on a side of the water inlet tube 94 opposite from the tank side wall 101, such that the water inlet tube and its outlet lie in a relatively small vertically extending water refill chamber or area 103 of the tank defined between the tank side wall 101 and baffle plate 102. The baffle plate 102 is generally planar and rectangular in shape, is carried at its upper end by the top cover 26 by means of a pair of posts 104 and 106 of the baffle plate that are received and secured in cover openings 108 and 110, and extends in the horizontal direction substantially from side-to-side of the boiler tank 24 and in the vertical direction from the cover to a point toward but spaced from the boiler tank bottom wall 111, such that the baffle divides the tank into the relatively small cold water inlet chamber 103 on one of its sides and a main and relatively larger water heating chamber 114 on its opposite side, with the bottom of the baffle plate being spaced from the tank bottom wall 111 to define an elongate opening 116 between the chambers 103 and 114. The elongate opening 116 extends vertically from the bottom of the baffle plate 102 to the tank bottom wall 111 and horizontally from side-to-side of the tank, and provides communication between the cold water inlet chamber 103 and the water heating chamber 114 for a flow of relatively cold refill water from the chamber 103 into the chamber 114 in a relatively non-turbulent and quiescent manner.

The cold water inlet pipe connects to a supply of cold water through a water valve (not shown) that is controlled by the water level sensor 46 in a manner to maintain water in the tank at a lower level that is no lower than the bottom end of the water level sensor element 54 and at an upper level that is no higher than the bottom end of the water level sensor element 56. Following dispense of sufficient hot water from the boiler tank 24 to drop the level of hot water in the tank to just below the bottom end of the water level sensor element 54, to refill the tank and replenish water removed from the tank the water valve is opened for a flow of water from the water refill tube 94 into the water inlet chamber 103. Although water issuing from the lower outlet end of the refill tube 94 causes turbulence in the water in the water inlet chamber 103, the turbulence is confined to be within the chamber 103 by the baffle 102 and does not substantially extend into and affect the main body of heated water in the water heating chamber 114 on the opposite side of the baffle. This desirable result is achieved because the relatively cold refill water from the chamber 103 flows through the lower opening 116 and into the bottom of the water heating chamber 114 in a relatively linear and calm manner. As a result, the temperature gradient or stratification of the already heated hot water in the chamber 114 remains substantially undisturbed since the relatively cold refill water does not mix with and cool the already heated water. Contributing to a lack of induced turbulence in the hot water in the water heating chamber 114 is the area and length of the opening 116 between the chambers 103 and 114, which provides for a relatively reduced velocity and quiescent flow of cold water from the chamber 103 into the bottom of the chamber 114, as compared to that which occurs with conventional boilers. The overall temperature of the already heated water in the chamber 114 and at the hot water outlets from the chamber is therefore not significantly reduced, and hot water can immediately be dispensed from the boiler without first waiting for the water to be reheated. Boiler performance is thereby improved.

While one embodiment of the invention has been described in detail, various modifications and other embodiments thereof can be devised by one skilled in the art without departing from the spirit and scope of the invention, as defined in the appended claims.

What is claimed is:

1. A boiler assembly for a hot liquid dispenser, said boiler assembly comprising:
a boiler tank for containing liquid;
means separating said tank into a liquid receiving chamber and a liquid heating chamber;
means establishing communication between said chambers through an elongate opening extending along and adjacent to a bottom wall of said tank;
means for heating liquid in said liquid heating chamber;
means for dispensing heated liquid from said liquid heating chamber; and
means for delivering relatively cool liquid into said liquid receiving chamber for flow through said opening from said liquid receiving chamber into said liquid heating chamber to replace dispensed heated liquid without causing significant turbulence in the heated liquid.

2. A boiler assembly as in claim 1, wherein said separating means comprises a baffle plate extending from side to side and vertically within said tank and having one side spaced from a side wall of said tank to define said liquid receiving chamber between said one side and said tank side wall, said baffle plate defining said liquid heating chamber in said tank on an opposite side thereof and having bottom extending toward but spaced from said tank bottom wall to define said elongate opening between said liquid receiving and liquid heating chambers.

3. A boiler assembly as in claim 1, said liquid delivering means comprising a liquid supply line having an inlet coupled to a source of relatively cool liquid and an outlet located in said tank liquid receiving chamber at a height generally medially of the height of said tank, and a valve in said supply line operable to control a flow of liquid through said supply line, and including a liquid level sensing means in said tank for controlling operation of said valve to open said valve to flow liquid through said supply line and into said tank liquid receiving chamber upon sensing a minimum level of liquid in said liquid heating chamber and to dose said valve upon sensing a maximum level of liquid in said liquid heating chamber.

4. A boiler assembly for a hot liquid drink dispenser, said boiler assembly comprising:
a boiler tank for containing a supply of liquid drink;
vertically extending baffle means in said tank for dividing said tank into a relatively small and vertically extending liquid refill chamber and a relatively larger and vertically extending liquid heating chamber, said baffle means extending fully from side-to-side of said tank and from a top of said tank toward but spaced from a bottom of said tank to provide communication between said chambers via an elongate opening extending between a lower end of said baffle means and a bottom of said tank;
means for heating liquid in said liquid heating chamber;
means for dispensing heated liquid from said liquid heating chamber; and
means responsive to dispensing of heated liquid from said liquid heating chamber for introducing relatively cool liquid drink into said liquid refill chamber for flow from said liquid refill chamber into said liquid heating chamber through said opening to replace dispensed heated liquid without introducing substantial turbulence in or substantial mixing of the relatively cool liquid from said liquid drink refill chamber with the heated liquid in said liquid drink heating chamber.

5. A boiler assembly as in claim 4, said introducing means comprising a liquid drink supply line having an inlet coupled to a source of relatively cool liquid drink and an outlet located in said tank liquid drink receiving chamber at a height generally medially of the height of said tank, and a valve in said supply line operable to control a flow of liquid drink through said supply line, and including a heated liquid drink level sensing means in said tank for controlling operation of said valve to open said valve to flow liquid drink through said supply line and into said tank liquid receiving chamber upon sensing a minimum level of heated liquid in said tank and to close said valve upon sensing a maximum level of heated liquid in said tank.

6. A method of heating liquid in and dispensing liquid from a boiler tank of a hot liquid dispenser, comprising the steps of:
defining a relatively small liquid refill chamber and a relatively large liquid heating chamber in the boiler tank;
heating liquid in the liquid heating chamber;
dispensing heated liquid from the liquid heating chamber;
in response performance of said dispensing step, delivering relatively cool liquid into the liquid refill chamber; and
in response to performance of said delivering step, flowing liquid from the liquid refill chamber into a bottom of the liquid heating chamber in a smooth non-turbulent flow of liquid with no substantial mixing of liquid from the liquid refill chamber with heated liquid in the liquid heating chamber.

7. A method as in claim 6, wherein said defining step is performed by placing a baffle in the boiler tank to define the relatively small liquid refill chamber in the tank on one side of the baffle and the relatively large liquid heating chamber in the tank on the other side of the baffle.

8. A method as in claim 7, wherein said flowing step is performed by placing the baffle in the boiler tank such that a bottom of the baffle is spaced from the bottom of the tank to define an opening at the bottom of the tank between the liquid refill and liquid heating chambers.

9. A method as in claim 8, wherein the liquid refill and liquid heating chambers extend generally vertically in the boiler tank, and said delivering step is performed by introducing relatively cool liquid into the liquid refill chamber at a location generally medially of the height of the tank.

10. A method as in claim 6, including the step of sensing the level of liquid in the liquid heating chamber, and wherein said delivering step is responsive to said sensing step to deliver relatively cool liquid into the liquid refill chamber when a minimum level of liquid is sensed in the heating chamber and to terminate delivery of relatively cool liquid into the liquid refill chamber when a maximum level of liquid is sensed in the heating chamber.
